(19) United States
(12) Patent Application Publication
(10) Pub. No.: US 2021/0134302 A1
(43) Pub. Date: May 6, 2021

(54) ELECTRONIC APPARATUS AND METHOD THEREOF

(71) Applicant: Samsung Electronics Co., Ltd., Suwon-si (KR)

(72) Inventor: Jaesung KWON, Suwon-si (KR)

(73) Assignee: Samsung Electronics Co., Ltd., Suwon-si (KR)

(21) Appl. No.: 17/089,036

(22) Filed: Nov. 4, 2020

(30) Foreign Application Priority Data
Nov. 4, 2019 (KR) 10-2019-0139692

(51) Int. Cl. G10L 17/06; G10L 25/78; G10L 25/51

(52) U.S. Cl. CPC G10L 17/06; G10L 2025/783; G10L 25/51; G10L 25/78

(57) ABSTRACT

An electronic apparatus includes a processor configured to perform recognition for a plurality of first user voices input to a microphone to perform an operation corresponding to each of the user voices, obtain a plurality of voice groups in which the plurality of first user voices are classified by utterance characteristics, identify a voice group corresponding to a user among the plurality of obtained voice groups, and perform speaker recognition of the user for a second user voice input to the microphone based on utterance characteristics of the selected voice group.

### CROSS-REFERENCE TO RELATED APPLICATIONS

This application is based on and claims priority under 35 USC § 119 to Korean Patent Application No. 10-2019-0139692, filed on Nov. 4, 2019, the disclosure of which is herein incorporated by reference in its entirety.

### BACKGROUND

### 1. Field

The disclosure relates to an electronic apparatus that provides a speaker recognition function through user's utterance and a control method thereof.

### 2. Description of the Related Art

Speaker (user) recognition is to recognize whether a user is a legitimate user of an electronic apparatus through user's utterance input to the electronic apparatus. The speaker recognition is achieved by performing a speaker registration process of registering user's utterance to generate a speaker model and a speaker recognition process of comparing the speaker model generated in the speaker registration process with utterance to check whether a speaker is the registered speaker. In the speaker registration process, a sentence similar to an uttered word for the speaker recognition is shown to a user so that the user utters the sentence, and the electronic apparatus generates an individual speaker model with the uttered voice data. In the speaker recognition process, the speaker recognition is performed by detecting the speaker recognition utterance of the user and comparing the utterance with the registered speaker model.

### SUMMARY

The disclosure is to provide an electronic apparatus capable of more effectively performing speaker recognition, and a control method thereof.

According to an aspect of an embodiment, provided is an electronic apparatus including: a processor configured to perform recognition for a plurality of first user voices input to a microphone to perform an operation corresponding to each of the user voices, obtain a plurality of voice groups in which the plurality of first user voices are classified by utterance characteristics, select a voice group corresponding to a user from the plurality of obtained voice groups, and perform speaker recognition of the user for a second user voice input to the microphone based on utterance characteristics of the selected voice group.

The processor may generate a speaker model based on the utterance characteristics of the selected voice group, correct the generated speaker model by performing the recognition for the plurality of first user voices based on the generated speaker model, and perform the speaker recognition of the user based on the corrected speaker model.

The processor may select a voice group having most data of the first user voice from the plurality of voice groups as a voice group corresponding to the user.

The utterance characteristics may include at least one of tone, strength, and speed of the plurality of input first user voices.

The processor may correct the generated speaker model based on a first user voice whose similarity with the generated speaker model is equal to or greater than a threshold among the plurality of first user voices.

The processor may identify whether a speaker model corresponding to the user is generated, and generate the speaker model when the speaker model is not generated.

The processor may generate a plurality of speaker models for the user, identify similarity of utterance characteristics between the plurality of speaker models, and merge two or more speaker models having the similarity equal to or greater than a threshold.

According to another embodiment of the disclosure, provided is a control method of an electronic apparatus including: performing recognition for a plurality of first user voices input to a microphone to perform an operation corresponding to each of the user voices; obtaining a plurality of voice groups in which the plurality of first user voices are classified by utterance characteristics; selecting a voice group corresponding to a user from the plurality of obtained voice groups; and performing speaker recognition of the user for a second user voice input to the microphone based on utterance characteristics of the selected voice group.

The performing of the speaker recognition of the user may include generating a speaker model based on the utterance characteristics of the selected voice group, correcting the generated speaker model by performing the recognition for the plurality of first user voices based on the generated speaker model, and performing the speaker recognition of the user based on the corrected speaker model.

The selecting of the voice group includes selecting a voice group having most data of the first user voice among the plurality of voice groups as a voice group corresponding to the user.

The correcting of the generated speaker model may include correcting the generated speaker model based on a first user voice whose similarity with the generated speaker model is equal to or greater than a threshold among the plurality of first user voices.

The generating of the speaker model may include identifying whether a speaker model corresponding to the user is generated; and generating the speaker model when the speaker model is not generated.

The correcting of the speaker model may include: generating the plurality of speaker models for the user; identifying similarity of utterance characteristics between the plurality of speaker models; and merging two or more speaker models having the similarity equal to or greater than a threshold.

According to another embodiment of the disclosure, provided is a recording medium stored with a computer program including a code performing a control method of an electronic apparatus as a computer-readable code, in which the control method of the electronic apparatus may include performing recognition for a plurality of first user voices input to a microphone to perform an operation corresponding to each of the user voices; obtaining a plurality of voice groups in which the plurality of first user voices are classified by utterance characteristics; selecting a voice group corresponding to a user from the plurality of obtained voice groups; and performing speaker recognition of the user for a second user voice input to the microphone based on utterance characteristics of the selected voice group.

The disclosure may increase the user convenience by reducing the hassle that occurs in the speaker registration process when performing the speaker recognition.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a block diagram illustrating a configuration of an electronic apparatus according to an embodiment of the disclosure.

FIG. 2 is a diagram illustrating an operation flowchart of the electronic apparatus according to the embodiment of the disclosure.

FIG. 3 is a diagram illustrating an operation flowchart of the electronic apparatus according to the embodiment of the disclosure.

FIG. 4 is a diagram illustrating the amount of voice data for each voice group according to an embodiment of the disclosure.

FIG. 5 is a diagram illustrating an operation flowchart of the electronic apparatus according to the embodiment of the disclosure.

FIG. 6 is a diagram illustrating an operation flowchart of the electronic apparatus according to the embodiment of the disclosure.

FIG. 7 is a diagram illustrating a score table for a speaker model for each user voice according to an embodiment of the disclosure.

FIG. 8 is a diagram illustrating a table for utterance characteristics of a user voice according to an embodiment of the disclosure.

FIG. 9 is a diagram illustrating an operation flowchart of the electronic apparatus according to the embodiment of the disclosure.

FIG. 10 is a diagram illustrating a similarity table between speaker models according to an embodiment of the disclosure.

FIG. 11 is a diagram illustrating an operation flowchart of the electronic apparatus according to the embodiment of the disclosure.

### DETAILED DESCRIPTION

Hereinafter, embodiments of the disclosure will be described in detail with reference to the accompanying drawings. In the drawings, the same reference numbers or signs refer to components that perform substantially the same function, and the size of each component in the drawings may be exaggerated for clarity and convenience. However, the technical idea and the core configuration and operation of the disclosure are not limited only to the configuration or operation described in the following examples. In describing the disclosure, if it is determined that a detailed description of the known technology or configuration related to the disclosure may unnecessarily obscure the subject matter of the disclosure, the detailed description thereof will be omitted.

In embodiments of the disclosure, terms including ordinal numbers such as first and second are used only for the purpose of distinguishing one component from other components, and singular expressions include plural expressions unless the context clearly indicates otherwise. Also, in embodiments of the disclosure, it should be understood that terms such as ‘configured’, ‘include’, and ‘have’ do not preclude the existence or addition possibility of one or more other features or numbers, steps, operations, components, parts, or combinations thereof. In addition, in the embodiment of the disclosure, a ‘module’ or a ‘unit’ performs at least one function or operation, and may be implemented in hardware or software, or a combination of hardware and software, and may be integrated into at least one module. In addition, in embodiments of the disclosure, at least one of the plurality of elements refers to not only all of the plurality of elements, but also each one or all combinations thereof excluding the rest of the plurality of elements.

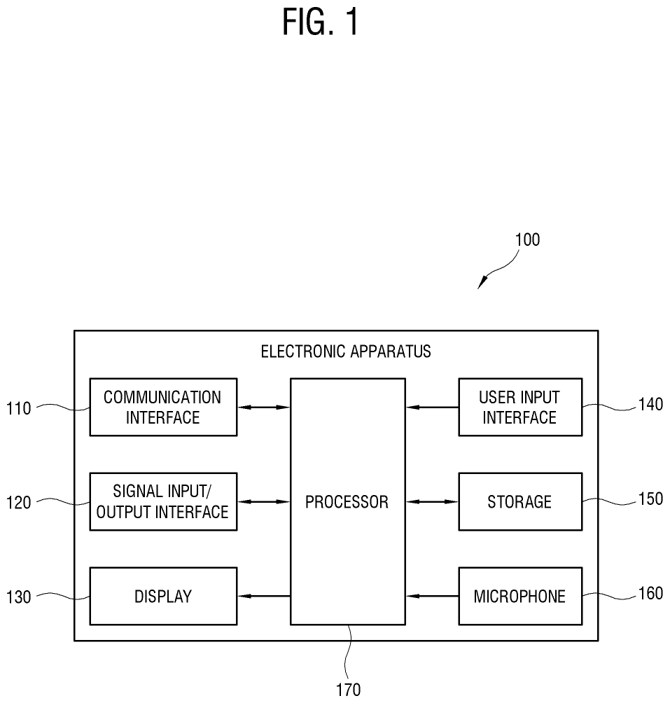

FIG. 1 is a block diagram illustrating a configuration of an electronic apparatus according to an embodiment of the disclosure. As illustrated in FIG. 1, an electronic apparatus 100 may include a communication interface 110, a signal input/output interface 120, a display 130, a user input interface 140, a storage 150, a microphone 160, and a processor 170.

Hereinafter, the configuration of the electronic apparatus 100 will be described. The electronic apparatus 100 may be implemented as a display apparatus capable of displaying an image. As an example, the electronic apparatus 100 may include a TV, a computer, a smartphone, a tablet, a portable media player, a wearable device, a video wall, an electronic frame, and the like. In addition, the electronic apparatus 100 may be implemented as various types of devices, such as an image processing device such as a set-top box without a display, household appliances such as a refrigerator and a washing machine, and an information processing device such as a computer body.

The electronic apparatus 100 may perform speaker recognition using a voice recognition function. When receiving a user voice, the electronic apparatus 100 obtains a voice signal for the user voice. In order to obtain the voice signal for the user voice, the electronic apparatus 100 may include the microphone 160 that collects the user voice, or may receive a voice signal from a remote controller having the microphone or an external apparatus such as a smartphone. The external apparatus may be provided with a remote controller application to perform a function of controlling the electronic apparatus 100, a function of the voice recognition, or the like. The external apparatus in which such an application is installed may receive the user voice, and the external apparatus may transmit and receive and control data using TV, Wi-Fi/BT, infrared rays, and the like, and therefore a plurality of communication interfaces 110 that may implement the above communication system may exist in the electronic apparatus.

The communication interface 110 is a two-way communication circuit that includes at least one of components such as communication modules and communication chips corresponding to various types of wired and wireless communication protocols. For example, the communication interface 110 is a LAN card that is connected to a router or gateway through Ethernet in a wired manner, a wireless communication module that performs wireless communication with an AP according to a W-Fi system, a wireless communication module that performs one-to-one direct wireless communication such as Bluetooth, or the like. The communication interface 110 may communicate with a server on a network to transmit and receive a data packet to and from the server. As another embodiment, the communication interface 110 may be connected to an external apparatus other than a server, and may receive various data including audio data from another external apparatus, or transmit various data including audio data to other external apparatus. When the microphone 160 provided in the electronic apparatus 100 receives voice or sound, the communication interface 110 converts an analog voice signal (or sound signal) into a digital voice signal and transmits the digital voice signal to the processor 170, and converts the analog voice signal into the digital voice signal when receiving the voice signal from the external apparatus and transmits the digital voice signal to the communication interface 110 using data transmission communication such as Bluetooth or

The signal input/output interface 120 is wired to a set-top box, an external apparatus such as an optical media playback device, an external display apparatus, a speaker, or the like in a 1:1 or 1:N (N is a natural number) manner to receive video/audio signals from the corresponding external apparatus or output the video/audio signals to the corresponding external apparatus. The signal input/output interface 120 includes a connector, a port, or the like according to a predetermined transmission standard, such as an High-Definition Multimedia Interface (HDMI) port, a Display Port (DP), a Digital Visual Interface (DVI) port, a thunderbolt, and a Universal Serial Bus (USB) port. At this time, for example, the HDMI, the DP, the thunderbolt, and the like are connectors or ports through which the video/audio signals may be transmitted simultaneously, and in another embodiment, the signal input/output interface 120 may include connectors or ports through which the video/audio signals, respectively, are transmitted separately.

The display 130 includes a display panel that may display an image on a screen. The display panel is provided as a light-receiving structure such as a liquid crystal type or a self-luminous structure such as an Organic Light-Emitting Diode (OLED) type. The display 130 may further include additional components according to the structure of the display panel. For example, if the display panel is a liquid crystal type, the display 130 includes a liquid crystal display panel, a backlight unit that supplies light, and a panel driving substrate that drives a liquid crystal of the liquid crystal display panel.

The user input interface 140 includes various types of input interface related circuits that are provided to perform user input. The user input interface 140 may be configured in various forms according to the type of the electronic apparatus 100, and includes, for example, a mechanical or electronic button unit of the electronic apparatus 100, a remote controller separate from the electronic apparatus 100, a touch pad, a touch screen installed on the display 130, and the like.

The storage 150 stores digitized data. The storage 150 includes a non-volatile storage that may preserve data regardless of whether or not the storage is supplied with power, and a volatile memory that may be loaded with data to be processed by the processor 170 and may not preserve data when the storage is not supplied with power. The storage includes a flash-memory, a hard-disc drive (HDD), a solid-state drive (SSD) read-only memory (ROM), and the like, and the memory includes a buffer, a random access memory (RAM), and the like.

The microphone 160 collects sounds of external environment including user voice. The microphone 160 transmits signals of the collected sound to the processor 170. The microphone 160 may be installed in a main body of the electronic apparatus 100 or may be installed in a remote controller separate from the main body of the electronic apparatus 100. In the latter case, the voice signal from the microphone is received from the remote controller to the communication interface 110.

The processor 170 includes one or more hardware processors implemented as a CPU, a chipset, a buffer, a circuit, and the like that are mounted on a printed circuit board, and may be implemented as a system on chip (SOC) depending on the design method. The processor 170 includes modules corresponding to various processes such as a demultiplexer, a decoder, a scaler, an audio digital signal processor (DSP), and an amplifier when the electronic apparatus 100 is implemented as a display apparatus. Here, some or all of these modules may be implemented as SOC. For example, a module related to image processing such as a demultiplexer, a decoder, and a scaler may be implemented as an image processing SOC, and an audio DSP may be implemented as a separate chipset from the SOC.

When obtaining the voice signal for the user voice by the microphone 160 or the like, the processor 170 may convert the voice signal into the voice data. At this time, the voice data may be text data obtained through a speech-to-text (STT) process that converts the voice signal into text data. The processor 170 identifies a command indicated by the voice data and performs an operation according to the identified command. The voice data processing process and the command identification and execution process may all be executed in the electronic apparatus 100. In this case, however, since a system load and a storage capacity required for the electronic apparatus 100 are relatively large, at least some of the processes may be performed by at least one server communicatively connected to the electronic apparatus 100 through a network.

In addition, when receiving the user voice, the processor 170 may identify utterance characteristics of the received user voice and perform speaker recognition for the user voice based on a speaker model corresponding to the identified utterance characteristics.

The electronic apparatus 100 may include at least one speaker model for the speaker recognition. The speaker model is a hardware/software component used to convert the voice signal according to the user voice into text data that may be interpreted by the processor or the like. The speaker model may include, for example, an acoustic model implemented through statistical modeling of uttered voice according to algorithms such as hidden Markov model (HMM) and dynamic time warping (DTW), a language model implemented through a collection of corpus (set of data collected in a form that a computer may process and analyze a text), and the like. The speaker model may be prepared to correspond to unique characteristics, such as utterance characteristics, by user data, corpus data, and the like which are used for model development. The utterance characteristics may include, for example, tone, strength, speed, frequency, period, and the like of the user voice. However, the utterance characteristics are not necessarily limited thereto.

The processor 170 according to the disclosure may call at least one instruction of software stored in a machine-readable storage medium such as the electronic apparatus 100, and execute the called instruction. This makes it possible for a device such as an electronic apparatus 100 to be operated to perform at least one function according to the at least one instructions called. The one or more instructions may include codes generated by a compiler or codes executable by an interpreter. The machine-readable storage medium may be provided in a form of a non-transitory storage medium. Here, the ‘non-transitory’ means that the storage medium is a tangible device, and does not include a signal (for example, electromagnetic waves), and the term does not distinguish between the case where data is stored semi-permanently on a storage medium and the case where data is temporarily stored thereon.

Meanwhile, the processor 170 may identify the utterance characteristics of the user voice received by the microphone 160 or the like, and perform at least a part of data analysis, processing, and result information generation for performing the speaker recognition operation of the user voice based on the speaker model corresponding to the identified utterance characteristics using at least one of a machine learning, a neural network, or a deep learning algorithm as a rule-based or an artificial intelligence algorithm.

For example, the processor 170 may perform functions of a learning unit and a recognition unit together. The learning unit may perform a function of generating a trained neural network, and the recognition unit may perform a function of recognizing (or reasoning, predicting, estimating, and determining) data using the trained neural network. The learning unit may generate or update the neural network. The learning unit may obtain training data to generate the neural network. For example, the learning unit may obtain training data from storage 150 or from the outside. The training data may be data used for training the neural network, and the neural network may be trained using the data performing the above-described operation as the training data.

Before training the neural network using the training data, the learning unit may perform a pre-processing operation on the obtained training data, or select data to be used for training from a plurality of pieces of training data. For example, the learning unit may process or filter the training data in a predetermined format, or add/remove noise to process data in a form suitable for training. The learning unit may generate a neural network configured to perform the above-described operation using the pre-processed training data.

The trained neural network may be constituted by a plurality of neural networks (or layers). Nodes of the plurality of neural networks have weights, and the plurality of neural networks may be connected to each other so that an output value of one neural network is used as an input value of another neural network. Examples of neural networks may include models such as a convolutional neural network (CNN), a deep neural network (DNN), a recurrent neural network (RNN), a restricted Boltzmann machine (RBM), a deep belief network (DBN), a bidirectional recurrent deep neural network (BRDNN), and deep Q-networks.

Meanwhile, in order to perform the above-described operation, the recognition unit may obtain target data. The target data may be obtained from the storage 150 or from the outside. The target data may be data to be recognized by the neural network. Before applying to the target data to the trained neural network, the recognition unit may perform the pre-processing operation on the obtained target data, or select data to be used for recognition from a plurality of target data. For example, the recognition unit may process or filter the target data in a predetermined format, or add/remove noise to process data in a form suitable for recognition. The recognition unit may obtain an output value output from the neural network by applying the preprocessed target data to the neural network. The recognition unit may obtain a probability value or a reliability value along with the output value.

For example, the control method of the electronic apparatus 100 according to the disclosure may be provided as being included in a computer program product. The computer program product may include instructions of software executed by the processor 170 as described above. The computer program product may be traded as a product between a seller and a purchaser. The computer program product may be distributed in the form of a machine-readable storage medium (for example, CD-ROM), or may be distributed (for example, download or upload) through an application store (for example, Play Store™) or may be directly distributed (for example, download or upload) between two user devices (for example, smartphones) online. In case of the online distribution, at least a portion of the computer program product may be at least temporarily stored in a storage medium such as a memory of a server of a manufacturer, a server of an application store, or a memory of a relay server or be temporarily generated.

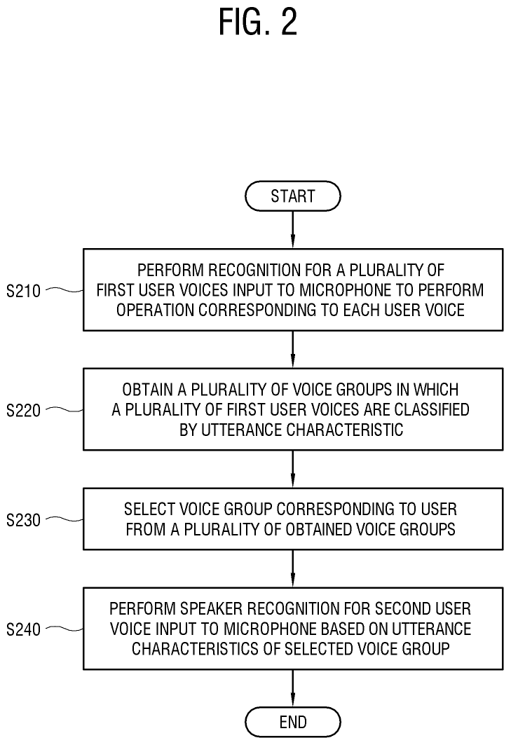

FIG. 2 is a diagram illustrating an operation flowchart of the electronic apparatus according to the embodiment of the disclosure. According to the embodiment of the disclosure, the processor 170 performs an operation corresponding to each user voice by recognizing the plurality of user voices input to the microphone 160 (S210). At this time, the processor 170 obtains a plurality of voice groups classified by the utterance characteristics of the plurality of user voices (S220). At this time, the utterance characteristics according to the embodiment of the disclosure may include, for example, tone, strength, speed, frequency, period, and the like of the user voice. However, the utterance characteristics are not necessarily limited thereto. Accordingly, when the plurality of user voices are input, the processor 170 according to the present embodiment may identify the utterance characteristics of the input user voice and classify the identified utterance characteristics for each user voice having similar utterance characteristics. Thereafter, the processor 170 selects (or identifies) a voice group corresponding to the user from the plurality of obtained voice groups (S230), and performs the speaker recognition for the user voice input to the microphone based on the utterance characteristics of the selected voice group (S240). Therefore, according to the embodiment of the disclosure, even without going through a separate speaker registration process for the speaker recognition, the speaker recognition is possible only with the user voice accumulated according to the operation of the electronic apparatus 100, thereby improving the user convenience. As another embodiment, S220 and S230 may be combined and performed as a single step.

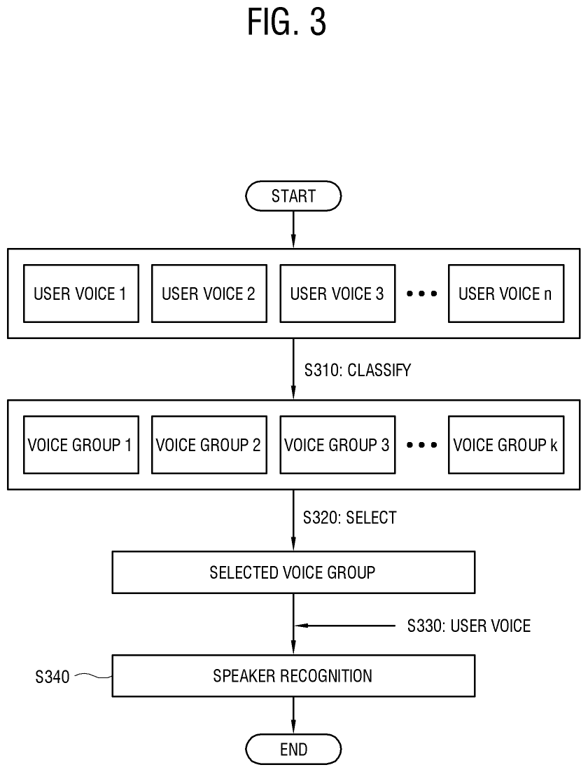

FIG. 3 is a diagram illustrating the operation flowchart of the electronic apparatus according to the embodiment of the disclosure. FIG. 3 will be described in more detail the contents illustrated in FIG. 2. According to the embodiment of the disclosure, a plurality of user voices, for example, user voice 1, user voice 2, user voice 3, . . . , user voice n, and the like may be input through the microphone 160 or the like. The processor 170 of the disclosure may classify user voices having similar utterance characteristics based on the utterance characteristics of the plurality of user voices into voice group 1, voice group 2, voice group 3, . . . , and voice group k, and the like (S310). The processor 170 may generate voice groups for each user by making the number of users and the number of voice groups the same, or generate voice groups so that the number of users and the number of voice groups are not the same. At this time, it is easy to form the voice group in the electronic apparatus 100, and in order to increase the accuracy of the formed voice group, the number of user voices is secured so that the probability of occurrence of an error in the voice group classification is equal to or less than a predetermined value.

After the plurality of user voices are classified into the plurality of voice groups according to the embodiment of the disclosure, the processor 170 selects one of the plurality of voice groups (S320). In this case, in order to specify the user of the electronic apparatus 100, the processor 170 selects a voice group including the largest number of user voices from the classified voice groups, and recognizes a user who makes utterance corresponding to the selected voice group as a user using the electronic apparatus 100. This is because the probability that a person who uses the electronic apparatus 100 most often is a user who will perform the speaker recognition in the electronic apparatus 100 is high. However, the method of specifying a user is not limited to the number of user voices, and various other methods may be used. For example, the processor 170 may obtain user information through another path, and may identify the association between the user voice and the user based on the obtained information.

At this time, the voice group having the largest number of user voices may be selected according to the following Equation 1 below.

DataSet(cluster*)=arg max_{K=1,2, . . . ,k}(count(utterances|cluster K)) [Equation 1]

After the user is recognized, when the user voice is input to the electronic apparatus 100 (S330), the processor 170 compares the input user voice with the utterance characteristics of the selected voice group to identify whether the voice input is due to the same user (S340). If the input user voice and the utterance characteristics of the voice group are similar, it may be recognized as the user of the electronic apparatus 100.

As described above, the electronic apparatus 100 may select one voice group, but is not limited thereto, and select a voice group having the largest number of user voices and then select a voice group having the second largest number of user voices to recognize a plurality of users.

Accordingly, according to the embodiment of the disclosure, in order to select the voice group, the reliability of the speaker recognition may be increased in consideration of the number of user voices for each voice group, and the like.

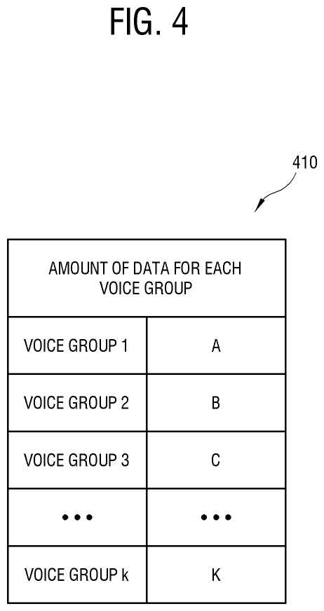

FIG. 4 is a diagram illustrating an amount of voice data for each voice group according to an embodiment of the disclosure. According to the embodiment of the disclosure, the processor 170 classifies the plurality of user voices into user voices having similar utterance characteristics. Thus, it is assumed that the plurality of user voices are divided into the voice group 1, the voice group 2, the voice group 3, . . . , and the voice group k, and the amount of voice data each of the voice groups has is A1, A2, A3, . . . , and Ak. In this case, the processor 170 may select the voice group having the largest number of user voice data among the k voice groups as the voice group corresponding to the user. The reason that the data of the user voice having specific utterance characteristics is the most is because it may be seen that the electronic apparatus is used most frequently among a plurality of users using the electronic apparatus 100. For example, when the amount of voice data of the voice group 3 is A3 which is the largest among k voice groups, it may be considered that a user who utters a user voice corresponding to the voice group 3 uses the electronic apparatus 100 most often, and the electronic apparatus 100 may recognize the user who utters the user voice as a user. Accordingly, according to the embodiment of the disclosure, it is possible to understand whether a main user of the electronic apparatus exists, how many people mainly uses the electronic apparatus, and the like, based on the amount of voice data for each voice group.

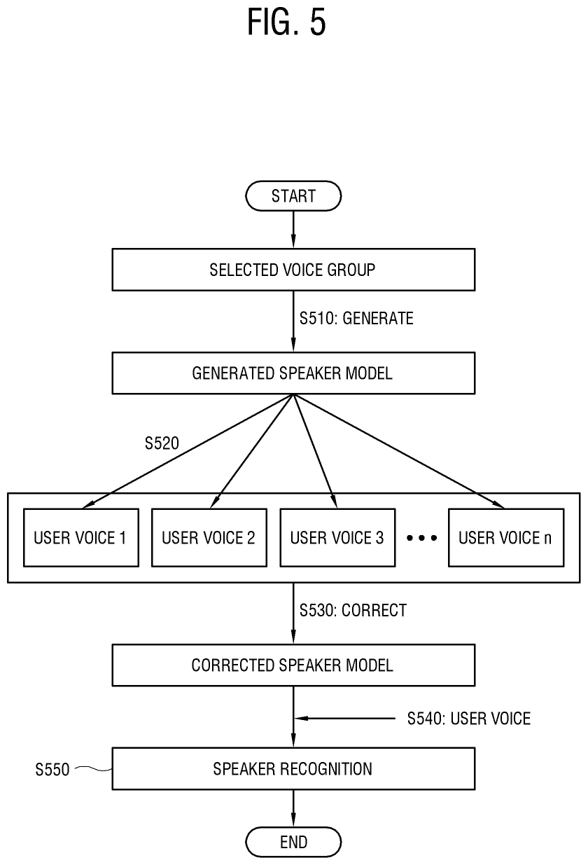

FIG. 5 is a diagram illustrating the operation flowchart of the electronic apparatus according to the embodiment of the disclosure. The processor 170 may select a voice group including the largest number of user voices from the plurality of voice groups, and generate a speaker model by the selected voice group (S510). Since voice data of a specific user may be included in not only the selected specific voice group but also other voice groups, a specific speaker model is generated by the selected specific voice group to classify all the user voices again. Accordingly, the processor 170 may recognize a plurality of user voices based on the generated speaker model (S520) and correct the generated speaker model (S530). After the speaker model is corrected, when the user voice is input to the electronic apparatus 100 (S540), the processor 170 may perform speaker recognition of the user based on the corrected speaker model (S550). One embodiment of the disclosure is not limited to the generation and correction of one speaker model, and a plurality of speaker models are generated and corrected for user voices remaining by selecting one of a plurality of voice groups and newly input user voices.

Therefore, according to the embodiment of the disclosure, the accuracy of the speaker recognition may be more improved by correcting the generated speaker model, instead of performing the speaker recognition with only the selected voice group itself, and the reliability can be increased by classifying and identifying the same user voice into different voice groups.

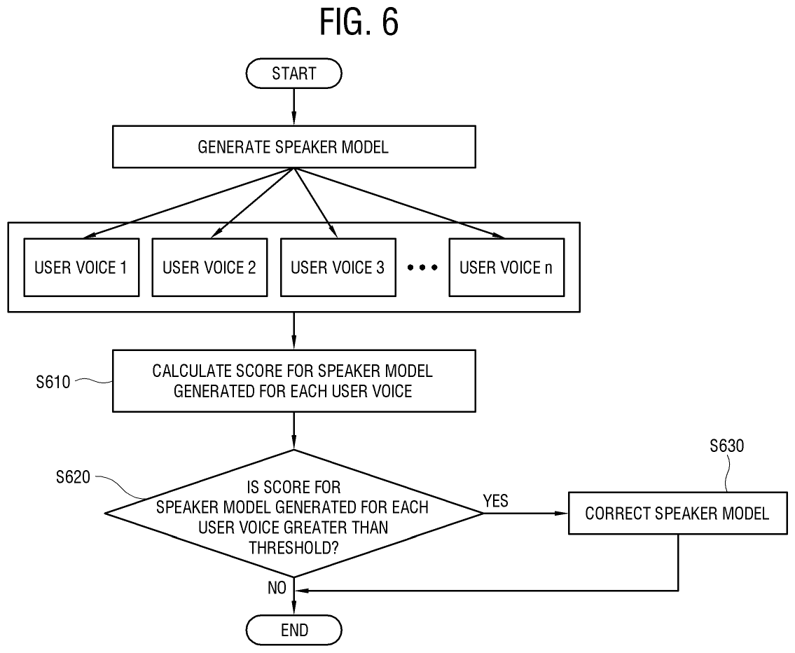

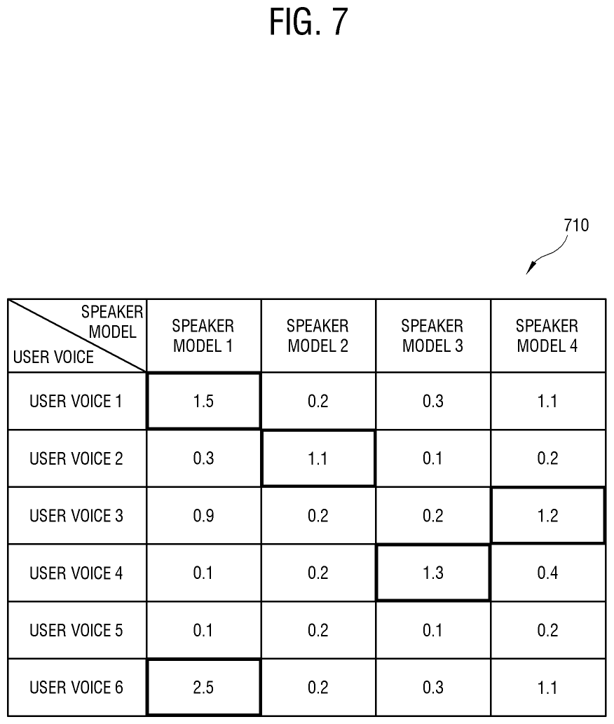

FIG. 6 is a diagram illustrating the operation flowchart of the electronic apparatus according to the embodiment of the disclosure, and FIG. 7 is a diagram illustrating a score table for the speaker model for each user voice according to the embodiment of the disclosure.

According to the embodiment of the disclosure, when the speaker model is generated, the processor 170 may calculate scores for each of the plurality of user voices based on the utterance characteristics of the generated speaker model (S610). In this case, there may be at least one speaker model generated in the electronic apparatus 100. According to a table 710 illustrated in FIG. 7, it is assumed that, for example, speaker model 1, speaker model 2, speaker model 3, and speaker model 4 are generated based on the plurality of user voices. At this time, assuming that a threshold of the score for the speaker recognition is 1, the score is calculated by comparing user voice 1 to user voice 6 with utterance characteristics of the four speaker models generated. In addition, the processor 170 may determine whether or not the calculated score for each user voice is greater than the threshold for the speaker recognition using the speaker model (S620). In this case, the fact that the calculated scores for each user voice are greater than the threshold for the speaker recognition using the speaker model means that a specific user voice is recognized as similar to utterance characteristics of a specific speaker model. For example, in FIG. 7, the user voice 1 may be recognized as the speaker model 1 and the speaker model 4 having scores exceeding a threshold of 1, but since the score for the speaker model 1 is 1.5, which is greater than 1.1 which is the score for the speaker model 4, the user voice 1 may be recognized as corresponding to the speaker model 1. Determining the remaining utterances, the user voice 2 may be recognized as the speaker model 2, the user voice 3 may be recognized as the speaker model 4, the user voice 4 may be recognized as the speaker model 3, and the user voice 6 may be recognized as the speaker model 1. For the user voice 5, it may be seen that the speaker recognition is not possible because the scores for all the generated speaker models do not exceed the speaker recognition threshold 1.

When the scores for the user voice and the utterance characteristics of one of the generated speaker models are greater than the threshold (Yes in S620), the processor 170 regards the corresponding user voice as similar to the utterance characteristics of the corresponding speaker model and merges the user voice data with the data of the speaker model to correct the speaker model. For example, in FIG. 7, it is assumed that for the speaker model 1, only the data of the user voice 1 is included and the data of the user voice 6 is not included. Referring to the table 710 of FIG. 7, the user voice 1 and the user voice 6 each have the scores for the speaker model 1 of 1.5 and 2.5, which are greater than the threshold, so it may be determined that the user voice 1 and the user voice 6 are similar to the utterance characteristics of the speaker model 1. Accordingly, after the speaker model 1 is generated, the processor 170 may classify the user voice 6 into the speaker model 1 and correct the speaker model 1. According to the embodiment of the disclosure, after the speaker model is generated, the speaker model can be elaborately constructed by continuously correcting the speaker model using the user voices stored in the storage 150 as well as newly received user voices.

On the other hand, the user voice having a score lower than the threshold is determined as the user voice different from the generated speaker model, and the processor 170 may store the user voice back in the storage 150. The corresponding user voice may generate a new model along with user voices having similar utterance characteristics in the future. For example, in FIG. 7, since the scores of the generated model in respect to user voice 5 do not exceed the threshold, it means that the speaker model corresponding to the utterance characteristics of the user voice 5 has not been generated. Therefore, the processor 170 may store the data of the user voice 5 back in the storage 150 and use the stored data to generate a new model later.

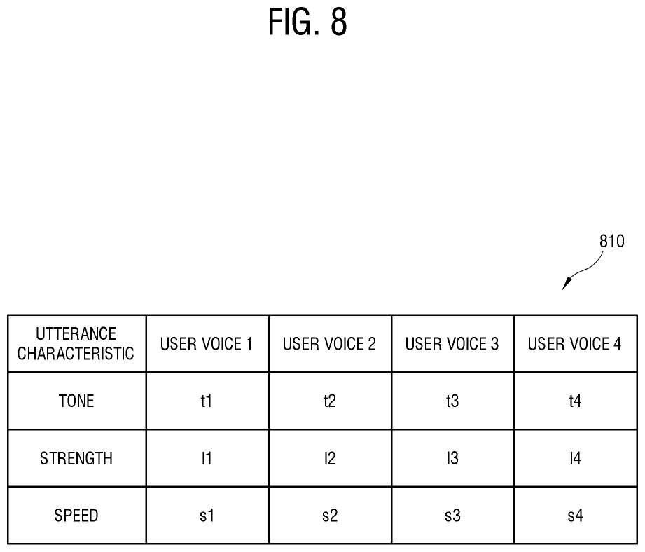

FIG. 8 is a diagram illustrating a table 810 for utterance characteristics of the user voice according to an embodiment of the disclosure.

The utterance characteristics according to the embodiment of the disclosure may include at least one of tone, strength, and speed of a plurality of user voices input to the electronic apparatus 100. For example, assume that the user voice 1, the user voice 2, the user voice 3, and the user voice 4 are stored in the storage 150 of the electronic apparatus 100. For the user voice 1, the tone has t1, the strength has 11, and the speed has s1, for the user voice 2, the tone has t2, the strength has 12, and the speed has s2, for the user voice 3, the tone has t3, the strength has 13, and the speed has s3, and for the user voice 4, the tone has t4, the strength has 14, and the speed has s4. The processor 170 may calculate the scores for the speaker models generated for each of the plurality of user voices described in FIGS. 6 and 7 based on the utterance characteristics of each user voice. By converting the utterance characteristics according to the embodiment of the disclosure into data, a comparison of the user voice and the utterance characteristics of the speaker model may be performed in detail.

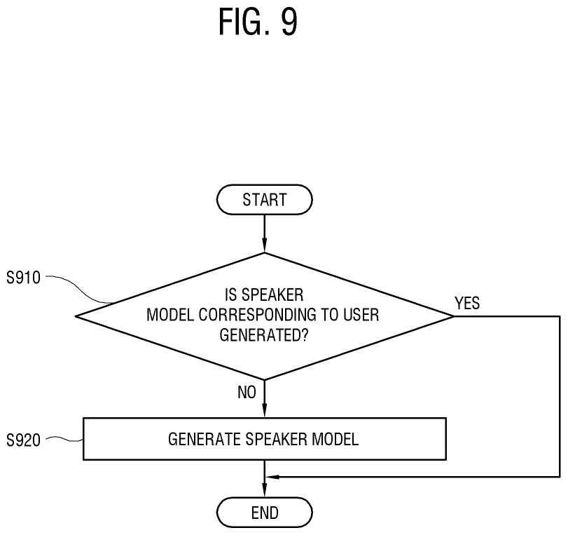

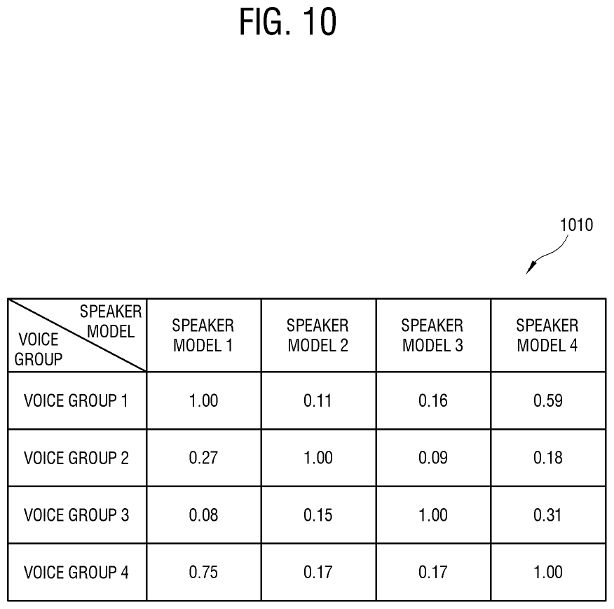

FIG. 9 is a diagram illustrating the operation flowchart of the electronic apparatus according to the embodiment of the disclosure, and FIG. 10 is a diagram illustrating a similarity table between the speaker models according to the embodiment of the disclosure. According to the embodiment of the disclosure, in the process of generating the speaker model, a speaker model identical to the existing generated speaker model may be generated, and a plurality of speaker models corresponding to one user may be generated. This is because the utterance characteristics of the user voice are recognized differently due to variations in the user's utterance characteristics, the surrounding environment, and the like, and thus the user voice may be included in other models. Accordingly, the processor 170 may determine whether the speaker model corresponding to the user is generated by calculating the similarity between the speaker models (S910). The similarity between the speaker models can be calculated by the following Equation.

$$\begin{matrix}{u}_{ij} = \frac{{S}_{j}}{{S}_{i}} & [ Equation 2 ] \\ {U}_{ij} = \frac{\sum {u}_{ij}}{utt count of recognized as i model} & [ Equation 3 ]\end{matrix}$$

The similarity uij in the above Equation 2 represents a ratio of a score Si for each user voice of an i speaker model and a score Sj for each user voice of a j speaker model. At this time, the similarity uij is rounded off to the third decimal place to concisely indicate the similarity. For example, referring to the table 710 of FIG. 7, the scores for the speaker model 1 and the speaker model 2 for the user voice 2 are 0.3 and 1.1, respectively. If the similarity of the speaker model 1 to the speaker model 2 is expressed using the above Equation 2, the similarity is 0.3/1.1 and thus becomes 0.27. Similarly, referring to the table 710 of FIG. 7, when the similarity is expressed by the score for the speaker model 2 and the score for the speaker model 3 for the user voice 2, the similarity is 0.1/1.1 and thus becomes 0.09. A similarity table 1010 of FIG. 10 can be filled using the scores of the remaining user voices and speaker models.

However, as illustrated in FIG. 7, the speaker model 1 may correspond to the user voice 1 and the user voice 6. As such, when a plurality of user voices correspond to one speaker model, the similarity between the speaker models may be calculated by the above Equation 3. Since the speaker model is composed of a plurality of user voices, in fact, the similarity between the speaker models can be seen as the total similarity uij of the above Equation 3. The total similarity uij in the above Equation 3 is a value obtained by dividing the sum of the similarity uij between the i speaker model and the j speaker model by the number of user voices corresponding to the i speaker model. For example, the similarity of the speaker model 2 with respect to the speaker model 1 is calculated. Referring to the table 710 of FIG. 7, the scores for the speaker model 1 and the speaker model 2 for the user voice 1 each are 1.5 and 0.2, and the scores for the speaker model 1 and the speaker model 2 for the user voice 6 each are 2.5 and 0.2. By the above Equation 2, the similarity between the speaker models for each user voice is 0.2/1.5 and 0.2/2.5. Accordingly, the total similarity of the speaker model 2 with respect to the speaker model 1 shown in the table 1010 of FIG. 10 is a value obtained by dividing the similarity between the speaker models for each user voice by the number of user voices. In other words, the similarity is (0.2/1.5+0.2/2.5)/2 and thus becomes about 0.11.

In this way, the processor 170 may obtain the similarity between the speaker models, and may determine that speaker models with the similarity exceeding a predetermined value according to a predetermined criterion are similar. If it is not identified that the speaker model corresponding to the user is generated (No in S910), the processor 170 generates a new speaker model (S920).

Accordingly, the electronic apparatus 100 may prevent a plurality of identical speaker models from being generated.

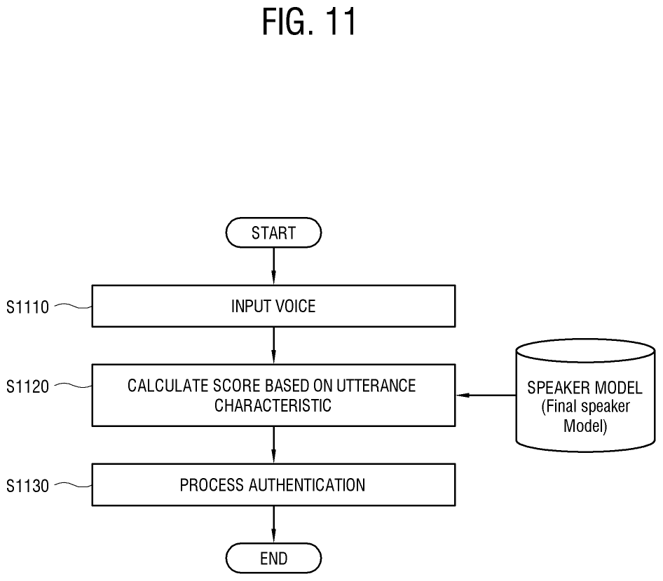

FIG. 11 is a diagram illustrating the operation flowchart of the electronic apparatus according to the embodiment of the disclosure. According to the embodiment of the disclosure, when a voice is input to the electronic apparatus 100 (S1110), a score is calculated for the user voice based on the utterance characteristics of the generated speaker model (S1120), and when the calculated score exceeds the threshold, authentication is performed as the user of the electronic apparatus (S1130).

1. An electronic apparatus, comprising:
a processor configured to
perform an operation corresponding to a plurality of first user voices input to a microphone,
identify a voice group corresponding to a user among the plurality of voice groups, the plurality of voice groups being classified according to utterance characteristics of the plurality of first user voices, and
perform speaker recognition of the user for a second user voice input to the microphone based on the utterance characteristics of the identified voice group.

2. The electronic apparatus of claim 1, wherein the processor is further configured to:
generate a speaker model based on the utterance characteristics of the identified voice group;
correct the generated speaker model by performing recognition for the plurality of first user voices based on the generated speaker model; and
perform the speaker recognition of the user based on the corrected speaker model.

3. The electronic apparatus of claim 1, wherein the processor is further configured to identify the voice group having most data of the first user voices among the plurality of voice groups as the voice group corresponding to the user.

4. The electronic apparatus of claim 1, wherein the utterance characteristics include at least one of tone, strength, and speed of the plurality of input first user voices.

5. The electronic apparatus of claim 2, wherein the processor is further configured to correct the generated speaker model based on a first user voice whose similarity with the generated speaker model being equal to or greater than a threshold among the plurality of first user voices.

6. The electronic apparatus of claim 2, wherein the processor is further configured to:
identify whether the speaker model corresponding to the user is generated; and
generate the speaker model when the speaker model is not generated.

7. The electronic apparatus of claim 2, wherein the processor is configured to:
generate a plurality of speaker models for the user;
identify similarity of utterance characteristics between the plurality of speaker models; and
merge two or more speaker models having the similarity equal to or greater than a threshold.

8. A control method of an electronic apparatus, comprising:
performing an operation corresponding to a plurality of first user voices input to a microphone;
identifying a voice group corresponding to a user among the plurality of voice groups, the plurality of voice groups being classified according to utterance characteristics of the plurality of first user voices; and
performing speaker recognition of the user for a second user voice input to the microphone based on the utterance characteristics of the identified voice group.

9. The control method of claim 8, wherein the performing of the speaker recognition of the user includes:
generating a speaker model based on the utterance characteristics of the identified voice group;
correcting the generated speaker model by performing the recognition for the plurality of first user voices based on the generated speaker model; and
performing the speaker recognition of the user based on the corrected speaker model.

10. The control method of claim 8, wherein the identifying of the voice group includes identifying the voice group having most data of the first user voice among the plurality of voice groups as the voice group corresponding to the user.

11. The control method of claim 8, wherein the utterance characteristics include at least one of tone, strength, and speed of the plurality of input first user voices.

12. The control method of claim 9, wherein the correcting of the generated speaker model includes correcting the generated speaker model based on the first user voice whose similarity with the generated speaker model being equal to or greater than a threshold among the plurality of first user voices.

13. The control method of claim 9, wherein the generating of the speaker model includes:
identifying whether the speaker model corresponding to the user is generated; and
generating the speaker model when the speaker model is not generated.

14. The control method of claim 9, wherein the correcting of the speaker model includes:
generating a plurality of speaker models for the user;
identifying similarity of utterance characteristics between the plurality of speaker models; and
merging two or more speaker models having the similarity equal to or greater than a threshold.

15. A non-transitory recording medium stored with a computer program including a code performing a control method of an electronic apparatus as a computer-readable code, wherein the control method of the electronic apparatus includes:
performing an operation corresponding to a plurality of first user voices input to a microphone;
identifying a voice group corresponding to a user among the plurality of voice groups the plurality of voice groups being classified according to utterance characteristics of the plurality of first user voices; and
performing speaker recognition of the user for a second user voice input to the microphone based on the utterance characteristics of the identified voice group.
